(19) United States
(12) Patent Application Publication
(10) Pub. No.: US 2025/0207909 A1
(43) Pub. Date: Jun. 26, 2025

(54) COMBINED PHOTOTHERMAL AND OCD FOR SEMI-OPAQUE STRUCTURES

(71) Applicant: NOVA LTD., Rehovot (IL)

(72) Inventors: Gilad Barak, Rehovot (IL); Yonatan OREN, Kiryat Ono (IL); Asaf ILOVITSH, Petah Tikva (IL)

(73) Assignee: NOVA LTD., Rehovot (IL)

(21) Appl. No.: 18/848,897

(22) PCT Filed: Mar. 20, 2023
(86) PCT No.: PCT/IB2023/052728

§ 371 Date: Sep. 19, 2024

Related U.S. Application Data
(60) Provisional application No. 63/321,732, filed on Mar. 20, 2022.

(51) Int. Cl. G01B 11/06

(52) U.S. Cl. CPC G01B 11/0616

(57) ABSTRACT

A metrology system that may include (i) thermal response critical dimensions (TRCD) optics that comprises pump beam optics and probe beam optics: wherein during a measurement iteration the pump beam optics are configured to illuminate the structure with a pump beam, and the probe beam optics are configured to illuminate the structure with a probe beam, to collect the response radiation and to sense the response radiation; and (ii) one or more modeling engines that are configured to determine at least one critical dimension of the structure based on the response radiation.

### CROSS REFERENCE

This application claims priority from U.S. provisional patent Ser. No. 63/321,732 filing date Mar. 20, 2022 which is incorporated herein by its entirety.

### BACKGROUND

Dimensional characterization solutions are a critical ingredient in semiconductor process control. Technologies such as Optical Critical Dimensions (OCD) and Critical-Dimensions Scanning Electron Microscopes (CD-SEM) are extensively used to provide dimensional characterization of semiconductor structures throughout the fabrication process. With modern advances in semiconductor metrology, new challenges are posed by emerging device working principles and designs.

One such challenge involves the characterization of opaque structures. When the measured structure is opaque to the probing mechanism (light, electron beam), characterization of the opaque layer (e.g. measuring its thickness) or structure embedded in\below it is not possible.

Several examples for such challenges are presented by the characterization of thick hard-masks used for high aspect-ratio structures, as in the example of 3D-NAND structures (see FIG. 1). The etch process into multiple-microns-thick dielectric stacks requires a deposition of few microns thick hard-mask, commonly made from amorphous Carbon. This layer is opaque to most characterization techniques, preventing high-end characterization-which is of crucial need in such delicate and high-end processes. Other examples involve metallic structures, where light penetration is prevented and characterization of CMOS Image Sensors at some fabrication process steps pose similar challenges.

These characterization challenges are exacerbated when measurement of multiple characteristics of the measured structure is needed, at high accuracy and precision. Such cases often render the few techniques available for opaque-layer characterization inadequate, due to their limited sensitivities to structural details and inability to separate between response to variations of different properties. FIG. 1 is a schematic sketch of a 3D-NAND structure 10, including a thick hard-mask 12. Patterned holes 14 in the hard-mask require accurate characterization, as they determine the quality of the following etch through the dielectric multi-layer underneath. Various layers such as dielectric layers 16 are positioned below the hard mask 12.

The mentioned challenge represents a broad family of use cases, and correspondingly a wide set of solutions—with varying advantages and limitations. The sensitivities offered by different methods to any given application may vary greatly, depending on the application geometry, materials and parameters of interest.

Some other methods are listed below.

Mid-InfraRed (MIR) scatterometry.

Some opaque layers become transparent (or at least offer deep penetration lengths) in the MIR. One such set of materials are amorphous-Carbon (aC) layers used for various coating applications. MIR scatterometry can employ reflectometry, ellipsometry or any other form of collecting a broadband spectrum and using it to deduce information on the studied structure.

These methods suffer from several inherent challenges. These include spot size (which cannot be reduced blow multiple tens of μm for MIR), system complexity and measurement time. Of course, arguably the most significant gap of MIR scatterometry is that the probed materials have to allow some of the illuminated light to pass, precluding very thick layers (e.g. aC above several microns thickness) and metals thicker than ˜100 nm (depending on specific metal).

Picosecond Ultrasonics (for example the Echo system of Onto Innovations of Wilmington, Massachusetts, USA).

This method involves a highly advanced pump-probe approach. An ultra-short ‘pump’ pulse is sent onto the sample inducing an acoustic wave in the material. This wave travels inside the structure and induces changes in the reflectivity properties. A second (‘probe’) pulse is sent onto the sample at some small time delay, probing the sample reflectivity at that time. By varying the time delay between pump and probe pulses, the acoustic response of the sample to the pump can be mapped, providing information on the sample internal structure. As the induce pulse traveling inside the material is not electromagnetic but rather acoustic, this method allows measurement of opaque layers.

A key deficiency of this method is the technical complexity involved. Picosecond Ultrasonics requires specific (ultra-short) laser sources, delay lines and fine control mechanisms to function accurately. Another deficiency relates to the method applicability to patterned nanostructures, as the signal sensitivity and attainable quality prevents accurate characterization of complex layouts.

Modulated Heating Black-Body Phase (MHBBP) response (for example—PCT patent application WO2019202275, and the coating thickness measurement device of Enovasense, Arcueil, France).

In this approach, a laser (‘pump’) is used to illuminate the sample and heat it, causing an increased emission of black-body radiation (BBR). Temperature increase is limited to few degrees at most, preventing sample damage. The BBR is predominantly emitted in MIR spectral range (well separated spectrally from the pump laser) providing direct monitor into the sample temperature change. Typically, a time-lag between the pump illumination and the temperature increase exists due to the time it takes the sample temperature to change. This time lag directly depends on the sample characteristics, where thinner\thicker layers will take different times to respond.

One beneficial approach to accurately monitor this time lag is by periodically modulate the pump laser and use lock-in detection for the MIR response, in which the phase difference between pump and MIR radiation (Δϕ) provides information on the sample thermal response time. By a correct choice of modulation frequency and even using several such modulation frequencies, sensitivities can be optimized.

This approach allows relatively simple and robust implementation. However, it is used for measurement of simple layer thicknesses, and cannot address complicated (patterned\structured) samples.

When used on patterned samples, the incident laser will not be absorbed in a well-defined region but rather cause distributed heating across the structure—as dictated by light interaction and penetration into the structure. In addition, BB radiation emitted from the pattern will also be affected by the structure, and its emergence from the structure may strongly depend on structural characteristics making interpretation unfeasible.

Another significant deficiency of this approach is the limited amount of information it offers. Each obtained measurement offers a single quantity (AQ), and even measurements obtained at multiple modulation frequencies (or, for that matter, excitation wavelengths, polarizations etc.) provides a single additional number. As such, it is impractical for metrology of complicated structures, characterized by multiple dimensions and parameters.

Importantly, this approach depends on the bulk-radiated thermal response: the measured signal is a volume-integral over the entire heated structure. As such, this approach would suffer from significant sensitivity degradation when measuring thin layers (as the active volume radiating heat would be reduced).

### BRIEF DESCRIPTION OF THE DRAWINGS

The embodiments of the disclosure will be understood and appreciated more fully from the following detailed description, taken in conjunction with the drawings in which:

FIG. 1 illustrates an example of a prior art sample;

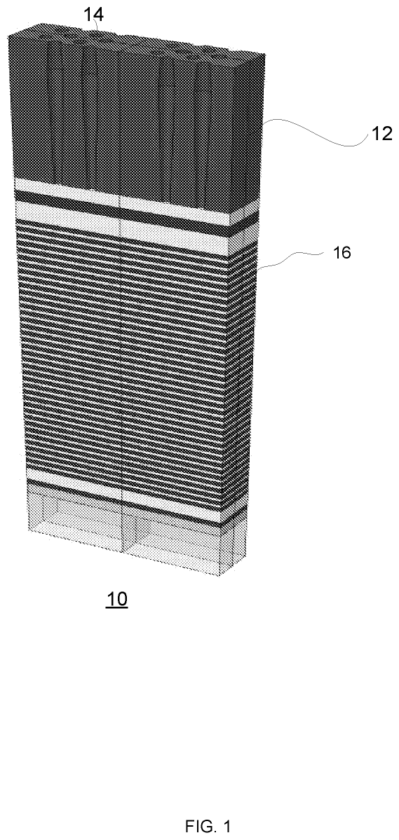

FIG. 2 illustrates an example of a metrology system;

FIG. 3 illustrates an example of a patterned illumination;

FIG. 4 illustrates an example of a method;

FIG. 5 illustrates an example of a method; and

FIG. 6 illustrates an example of a metrology system.

### DETAILED DESCRIPTION

In the following detailed description, numerous specific details are set forth in order to provide a thorough understanding of the embodiment. However, it will be understood by those skilled in the art that the present embodiment may be practiced without these specific details. In other instances, well-known methods, procedures, and components have not been described in detail so as not to obscure the present embodiment.

The subject matter regarded as the embodiment is particularly pointed out and distinctly claimed in the concluding portion of the specification. The embodiment, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present embodiment may for the most part, be implemented using electronic components and circuits known to those skilled in the art, details will not be explained in any greater extent than that considered necessary as illustrated above, for the understanding and appreciation of the underlying concepts of the present embodiment and in order not to obfuscate or distract from the teachings of the present embodiment.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

The specification and/or drawings may refer to a processor. The processor may be a processing circuit. The processing circuit may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an embodiment should be applied mutatis mutandis to one or more embodiments.

Any reference to a structure should be applied mutatis mutandis to one or more parts of a structure. The one or more parts of the structure may not form the entire structure. For example—illuminating the structure may mean that only one or more parts of the structure are illuminated. Yet for another example—collecting radiation emitted from the structure may mean that radiation emitted only from one or more parts of the structure are collected. The structure may have one or more dimensions of sub-millimetric order and even a micron or sub-micron order.

There may be provided a specific hardware implementation, simulative and algorithmic methodology and measurement approach. The method provides a high-end comprehensive characterization solution to complicated (patterned) structures containing opaque layers.

The suggested solution may include:
a. A hardware implementation combining together Optical Critical Dimensions (OCD) metrology and a Thermal-Response channel. This thermal response channel can include and MHBBP channel and\or a new proposed technology —Modulated Photo Thermal Probe (MPTP).
b. Structured-illumination can be used for both proposed thermal-response channels (MHBBP and MPTP), as a way to enrich the available information from these metrologies and access pattern-related sensitivities.
c. A modeling engine including full account for the interaction of the illuminated heating laser with the sample, the induced heating, time-dependent heat diffusion inside the structure and the resulting signal (blackbody radiation for MHBBP or thermo-reflectance response for MPTP) emerging from it. This modeling engine will be used to allow interpretation of the measured results in conjunction with the interpretation of the OCD channel (concurrently or serially). This part is important to allow use of the thermal-response techniques on patterned structures.

Below we explain each of these ingredients in more detail.

Combined metrology channels covering both transparent and opaque aspects of the measured target. Several optical methods are used today for optical critical dimension (OCD) metrology. Most common are Spectral Reflectometry, Spectral Ellipsometry and Spectral interferometry. The proposed metrology tool will include at least one such channel, functioning in the UV-Vis-NIR spectral ranges and allowing accurate characterization of the non-opaque portions of the measured structure. In the example presented above including a thick ‘hard-mask’ layer, these channels can only provide information on the top region of the measured structure, namely—such characteristics as the dimensions of the holes etched into this mask at the top surface.

A second metrology channel is to be combined onto the same platform—allowing characterization of opaque layers. This channel is explicitly required to be of simple technical design and implementation, allowing its combined integration together with the OCD metrology module in the same measurement unit. The first and second metrology channels may share one or more optical components. As such, high-end channels (such as MIR scatterometry or picosecond ultrasonics) are unsuitable for the purpose of this embodiment. The proposed implementation involves either using an MHBBP channel (see description above) or a new type of metrology channel—MPTP, which is describe below.

### Modulated Photo Thermal Probe (MPTP)

Photothermal response is the change of a sample optical properties due to heating. Measurement of such response is often used in characterization of material properties (e.g. using Photo Thermal Spectroscopy).

We propose a new use of the Photo Thermal response, intended for dimensional characterization, based on the temporal response of the sample to the applied heating.

The photothermal response can be highly wavelength-dependent and is typically linear with temperature, meaning:

$$R ( λ , T + Δ T ) - R ( λ , T ) = α ( λ ) \cdot T .$$

Here, R(λ, T) is the sample reflectivity at wavelength λ and temperature T, α(λ) is the photothermal response and ΔT a temperature change. Of course, many other details are omitted for clarity, e.g. dependence on polarization, angle-of-incidence (AOI) etc. A similar relation applies for other optical properties-such as transmission, refractive index and absorption coefficient.

The proposed method is based on (at least) two laser sources used in a pump-probe configuration.

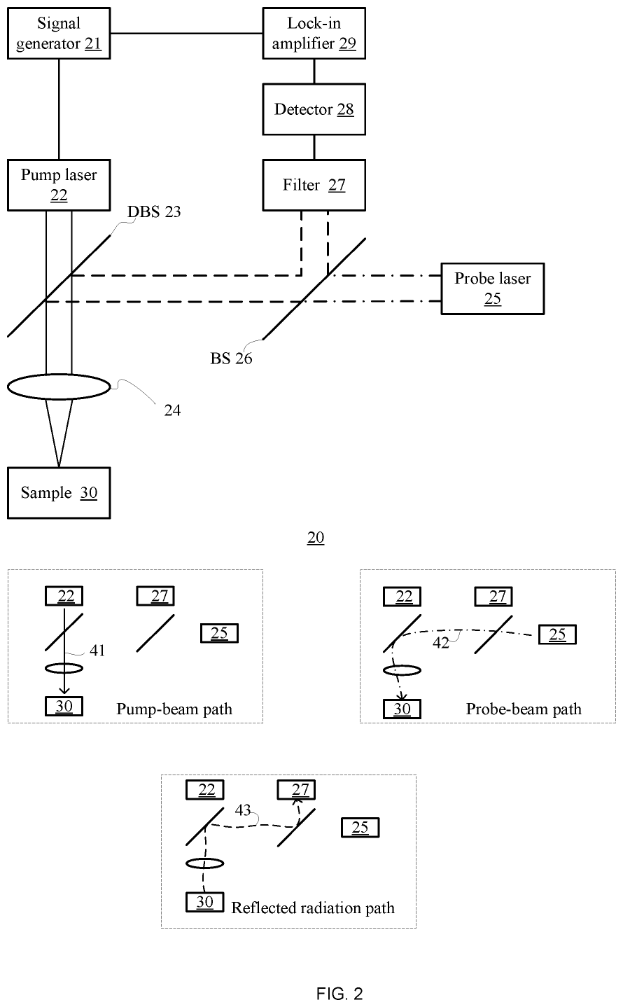

FIG. 2 illustrates an example of a system 20 that has thermal response critical dimensions (TRCD) optics, and also illustrates a pump beam 41 path through system 20, a probe beam 42 path through system 20 and a response radiation 43 path through system 20. The response radiation 43 is reflected due to the illumination of the sample with the probe beam 42. The response radiation reflected due to the illumination with the pump beam may or may not be ignored of.

FIG. 2 represents only one possible implementation of the system. Below we highlight few possible modifications for this layout, offering specific advantages and deficiencies.
a. A pump laser from pump laser 22 passes through a dichroic beam splitter (DBS) 23 with high transmission for pump wavelength and high reflectivity for the probe wavelength. This DBS can be replaced by a standard beam-splitter, at the penalty of having significant light loss from both the pump and probe. Pump and probe positions can be switched (with the dichroic reflection\transmission preferences adequately exchanged). The pump is then focused onto the sample by an objective lens 24.
b. Various optical elements can be added to the path, controlling the pump laser polarization, spot size and even angle-of-incidence and position on the sample.
c. The probe laser (from probe laser 25) passes through a beam splitter (BS) 26, reflected by the DBS 23 towards the objective lens 24 and focused onto the sample 30. Similarly to the pump path, various elements can be placed at the probe path to provide additional flexibility and degrees of freedom affecting the measured signal.
d. Both pump and probe lasers are reflected from the sample. The DBS 23 directs predominantly the probe laser back towards the BS 26, transmitting most of the pump light back towards its origin. Some portion of the beams is then directed by the BS 26 towards the detector 28, first passing through a filter 27 blocking any remainder pump laser from passing.
e. The detector can be a photodiode or any other light-sensitive sensor, which converts the light reaching it into an electronic signal. As needed, the signal generated by the detector is then amplified by an electronic amplifier such as lock-in amplifier (LIA) 29.
f. A signal generator 21 modulates the pump laser and provides synchronization signal to LIA 29. The LIA measures the phase between the pump pulse (referenced by the synchronization signal) and the thermal response.

At least the pump laser 22, objective lens 24 and DBS 23 may belong to pump beam optics. Other components such as but not limited to the BS 26 and the filter 27 may also be regarded as belonging to the pump beam optics.

The probe laser 25, BS 26, DBS 23, objective lens 24, filter 27 and detector 27 may belong to a probe beam optics.

While in FIG. 2 the probe beam optics and the pump beam optics share various components—there may be no shared components between the probe beam optics and the pump beam optics.

The sample temperature rise ΔT is dictated by heat diffusion from the region heated by the pump into and throughout the measured structure. For example, a thin absorptive layer with low heat capacity residing on a thermally-insulating dielectric layer will have a fast thermal response, and quickly react to the incident pump. In contrast, a very thick layer of large heat capacity will have a slower thermal response, requiring more time to heat up. Of course, the same rationale can be applied for the thermal response of complicated structures, although in such cases commonly a physical simulation engine is required to obtain accurate estimation of the expected heating.

This temporal dependence also infers that ΔT can significantly depend on the pump modulation frequencies, expressed as a phase difference between the pump and induced temperature. Measuring this phase difference is the basis of the MHBBP method.

MPTP metrology relies on the same modulation-frequency dependence of the pump-induced heating. However, probing the temperature change is done using a second (‘probe’) laser reflected from the sample. As the sample reflectivity changes with temperature (Eq. 1), the reflected probe intensity will change and these changes detected. The modulation frequency is set so as to provide best sensitivity to the measured parameters of interest. Multiple measurements at several modulation frequencies can offer different sensitivities to sample parameters, allow breaking of measurement correlations to these parameters and consequently-separate interpretation of multiple parameters.

As in MHBBP, a lock-in mechanism is used to accurately measure the phase lag due to the sample heating response time.

As described below, MPTP offers several significant advantages over MHBBP, in terms of attainable spot size, sensitivity to small\thin structures, added flexibility in choice of the probe characteristics, easy integration together with other UV-Vis-IR metrology channels and more.

Conversely, MHBBP offers several important advantages over MPTP. Arguably the most important advantage is that MHBBP does not require the sample to have any photothermal response: all materials emit black-body radiation, allowing extremely broad use of this method. MPTP requires the sample to change its reflectivity properties with heating—namely, requires that |α(λ)|>0 (in Eq. 1) at the probe wavelength. This condition may greatly depend on the measured sample. Another advantage of MHBBP is that it avoids the need to use a second laser source, somewhat simplifying implementation.

MPTP can be extended and improved with various modifications:
a. Pump: as described, heating is caused by the pump absorption inside the measured structure. Different pump wavelengths, polarizations and angles of incidence will be absorbed at different regions and efficiencies inside the structure, creating different response times. Such flexibility could allow measurement optimization for specific structures and characteristics of interest. Incorporating multiple measurements using several pump configurations could allow measurement of multiple parameters and improved robustness of the measurement to sample variations. These degrees of freedom are similar to what is possible in MHBBP.
b. Probe: a similar flexibility is possible for the probe channel-wavelengths, polarizations (at illumination and possibly separately at collection) and angle-of-incidence.
c. Addition of autofocus mechanism and navigation (imaging) channel are, of course, possible with the advantage of improved measurement stability and automation, at the expense of somewhat increased implementation complexity.

### Structured Illumination for Spatial Heat-Based Structural Mapping

A key deficiency of the described opto-thermal metrology approaches (MHBBP and MPTP) is the limited extent of information they provide and sensitivity to structural parameters. While measurements of simple, planar layers can be accurately addressed by these methods, when measuring a patterned structure they may not offer adequate sensitivity to lateral characteristics. This is a result of the vertical nature of heat diffusion from large-spot illumination: when considering micro- and nano-structures, the pump spot size is typically significantly larger than the measured structure dimensions. Consequently, heating is predominantly laterally homogeneous across the measured structure, resulting in heat diffusion being predominantly into the sample—in the vertical direction. Lateral heat diffusion will exist—due to the finite size of the pump illumination spot—but as it will take place on extremely large length scales (typically tens of microns or more), it will not be very poorly sensitive to details of the measured structure. Obtaining small-scale lateral heat diffusion is possible with significant decrease of the pump spot size, but at the significant penalty of greatly reduced signal intensity and correspondingly worse signal-to-noise (SNR) ratio. Very high SNR is of detrimental significance in both MHBBP and MPTP as they typically rely on extremely weak responses—either black-body radiation from close to room-temperature structures or from the very weak photothermal effect.

The goal of this part of the embodiment is to allow such lateral heat diffusion, while maintaining a large pump spot dimensions—and consequently high SNR. When diffusion includes lateral dynamics, the temperature increase reached by the structure and its time dependence will depend on this transport, providing additional sensitivity to structural properties.

To clarify this point, we argue that when considering a vertical heat transport through the structure it is possible to use an ‘effective medium’ approach in which the patterned structure is replaced with a simple layered equivalent structure, with the different layers having ‘effective’ material properties (heat diffusivity, heat capacitance etc.) describing how heat is transported between the layers. While such equivalence is not entirely accurate, it commonly provides very good approximation to the sample thermal response. Conversely, in the approach proposed below heat diffusion will depend on both lateral and vertical diffusion properties.

The proposed approach involves using structured illumination for the pump beam, so that the sample heating is induced at a specific spatial frequency. More complicated illumination structure can be considered if beneficial.

The resulting measurement now has another important parameter, namely—the probe spot structure. Assuming periodic lines pattern (as in the example in FIG. 2), measurements now depend both on the pump modulation frequency ω_{Pump} and its lateral frequency Λ_{Pump}. Changes of these parameters affect heat diffusion into and across the structure during the illumination period, allowing sensitivity to structural parameters.

Implementation of the structured illumination can be accomplished through many, standard, methods and is not unique to this embodiment.

### Model-Based Interpretation (MBI)

Model-based interpretation approaches offer extremely powerful means for characterization, as they allow dealing with complex structures and deciphering the measured signal in terms of structural properties. Such methods are prevalent in OCD metrology, and also possible in some of the methods described above for measurement of opaque layers (e.g. MIR scatterometry). However, for reasons which will be discussed here, they are inapplicable—or at least extremely uncertain and challenging—for thermo-response approaches such as MHBBP and MPTP when applied to patterned samples. As we describe below, in this embodiment the combination of both an OCD channel and Thermo-Response channel offer an altogether new opportunity for model-based analysis. Such an interpretation approach, to the best of our knowledge, was not implemented previously.

To understand the challenge posed by using MBI for thermo-response metrology of patterned samples, we describe the required process for establishing such a modeling engine—as is has to calculate pump distribution, heat diffusion and generated signal (response).

Pump distribution: a first modeling stage involves simulating the distribution of illuminated electromagnetic (EM) field from the pump inside the structure. This can be accomplished by any EM-simulation engine (such as RCWA, FEM etc.). The EM field distribution can be converted into a distribution of heat sources through the local absorption coefficient of the sample. This distribution can be described either as a function of time or modulation frequency—J(x, y, z, ωₚᵤₘₚ). Of course, this distribution also depends on the pump wavelength, polarization, AOI etc., but these dependencies are omitted here for clarity. We note that this challenge is extremely simplified for simple layered structures, when analytic solutions are available. As discussed, this part of the current embodiment addresses patterned structure metrology.

Heat diffusion: given the heat source distribution, heat diffusion throughout the structure can be simulated. Of course, this simulation must take into account the time-dependence of the pump modulation. The result of this stage in the calculation is the heat distribution inside the sample—ΔT(ωₚᵤₘₚ, x, y, z). We note that ΔT in this representation is complex-valued, with a phase describing the time lag between pump and thermal response, meaning: ΔT(x, y, z, ωₚᵤₘₚ)=|ΔT(x, y, z, ωₚᵤₘₚ)|e^{ϕ(x,y,z,ω}^{ₚᵤₘₚ}). Here, ϕ(x, y, z, ωₚᵤₘₚ) is the phase difference between the temperature modulation at point (x, y, z) and the pump excitation.

Generated signal: the temperature change generates the thermo-response signal. However, details of this signal when measuring patterned structures are highly nontrivial and require a dedicated simulation stage.

MHBBP: each point in the structure is considered as a black-body (BB), broadband, radiation source. The temperature increase ΔT induces an increase in the BB radiation given by ΔW_{BB} (x, y, Z, ωₚᵤₘₚ, λ)=ϵ_{BB} (x, y, z)ΔB(ΔT (x, y, z, ωₚᵤₘₚ) Here, ϵ_{BB} (x, y, z) is the local emissivity and ΔB(ΔT) is the change in BB (Planck) radiation due to temperature increase ΔT (w.r.t. room temperature in this case).

We disregard various technical nuances which are immaterial for the described working principle, and are well understood in this physics discipline.

This radiation now has to exit the structure and be collected by the measurement apparatus. This process requires another stage of EM solution, this time including the spectral-dependence of the BB radiation as it travels inside the structure.

We define the spectral collection efficiency distribution—C(x, y, z, λ), which represents the efficiency by which light emitted at point (x, y, z) and wavelength λ can travel through the structure, reach the surface and be collected by the collection optics. The measured signal is then

I_{MHBBP}(ωₚᵤₘₚ)=∫_{λ}dλM(λ) ∫_{x,y,z}dxdydz C(x,y,z,λ)ΔW_{BB}(x,y,z,ωₚᵤₘₚ,λ)

We added the system spectral response M(λ) representing the collection transmission and detector efficiency.

MPTP: simulation here takes a different form from MHBBP. The probe reflectivity can be directly simulated in standard methods given the stack geometry and material parameters. This is common in OCD approaches, where the structure is first converted into a 3D distribution of dielectric constant ϵ(x, y, z) (not to be confused with ϵ_{BB}) and then the EM equations are solved for specific illumination and collection conditions. Such simulations provide the reflectivity (at chosen wavelength, polarization, AOI etc.)—I(ϵ₀) with ϵ₀ here representing the unperturbed dielectric constant distribution.

When simulating MPTP, it is important to know also the thermal response of the dielectric constant—dϵ(x,y,z)/dt, which is another material-dependent property. Given ΔT(x, y, z, ωₚᵤₘₚ), it is then possible to find the modulation of the dielectric constant

$$Δϵ ( x , y , z , {ω}_{pump} ) = \frac{d ϵ ( x , y , z )}{dT} Δ T ( x , y , z , {ω}_{pump} ) .$$

The MPTP signal is then given by

$${I}_{MPTP} ( {ω}_{pump} ) = I ( Δϵ ( {ω}_{pump} ) ) - I ( {ϵ}_{0} )$$

The spatial dependences of ϵ and Δϵ are implicit, for simplicity of notation.

This modeling approach is significantly more challenging than is currently used-both in OCD and in thermo-response approaches. However, it allows seamless integration of information from both type of metrology sources under the same framework.

This is not only beneficial in terms of using complementary information for interpretation, but rather is an enabler for thermo-response interpretation: the OCD information provides full description of the structure details at the regions where the pump is absorbed.

Consider for example the structure described in FIG. 2: pump penetration into the patterned holes and the induced heat distribution strongly depends on the holes geometry, which can be characterized using OCD. Lacking the OCD information, stage A of the above description (‘Pump distribution’) is not feasible-altogether preventing an accurate model-based approach for interpreting the thermo-optical information channel. In this way, the combination of OCD and thermo-optical metrology is extremely synergic, allowing this new form of characterization.

We will relate separately to three aspects detailed in this embodiment, namely: the MTPT method, the use of structured illumination and the combined use of OCD and thermo-response channels enabled by joint HW implementation and dedicated modeling engine.

### MTPT

As described, MTPT has several key advantages compared to alternative methods-most notably its simplicity of implementation (certainly compared to MIR scatterometry and picosecond ultrasonics). Compared to MHBBP, there are several important differences worth noting:

Volumetric vs. interface-related metrology:
a. MHBBP is sensitive to the integrated temperature increase across the entire measured structure (see Eq. 4). This is due to the BB radiation from the entire structure being collected at the detector. Conversely, MTPT measures the change in sample reflectivity. As such, it predominantly depends on changes of the reflectivity from interfaces between materials. To clarify this point, consider the simplest example of reflection from bulk material. MHBBP will collect signal from deep within the material, covering the entire heated volume (possibly with some attenuation vs. depth if MIR radiation is absorbed). MTPT is sensitive to reflection from the air-material interface, and (to an excellent approximation) can be shown to depend linearly on the change in the material refractive index due to heating. This distinction can have crucial impact on the relative sensitivities of MHBBP and MTPT: while characterization of thick layers may favor MHBBP, thin layers may be better served using MTPT.
b. Dependence on photoreflectance response: as described above, MTPT relies on changes of the optical properties of the measured materials with temperature (whereas none of the other methods described is). While this can be a deficiency when measuring materials with weak response, it offers an opportunity for significantly increased sensitivity by correct choice of probe wavelength. Using probe wavelengths where a (A) (Eq. 1) is especially large can greatly amplify the measured MTPT signal and improve performance.
c. Integration: of specific importance for the embodiment described herein is ease of integration of the thermo-response channel with OCD. Side-by-side integration, where the two metrologies have separate optical paths, allows great flexibility and (in essence) allows combining any of the mentioned metrology solutions with OCD. However, MTPT offers a unique opportunity of same-path integration: since both pump and probe wavelengths reside in the UV-NIR range, the same optical path can serve both OCD and MTPT measurements. In addition to greatly simplifying the HW implementation, sharing various functionalities (e.g. navigation, focus etc.)—such integration allows measurements of both channels with no sample movement, significantly improving throughput.

These relative advantages and disadvantages highlight the potential benefit from integrating both such channels onto the same platform.

### Structured Illumination

As far as we know, the idea of using structured illumination to affect thermal-distribution dynamics, as a way to improve thermal-response metrology represents a new approach. Existing metrology solutions don't have access to this information.

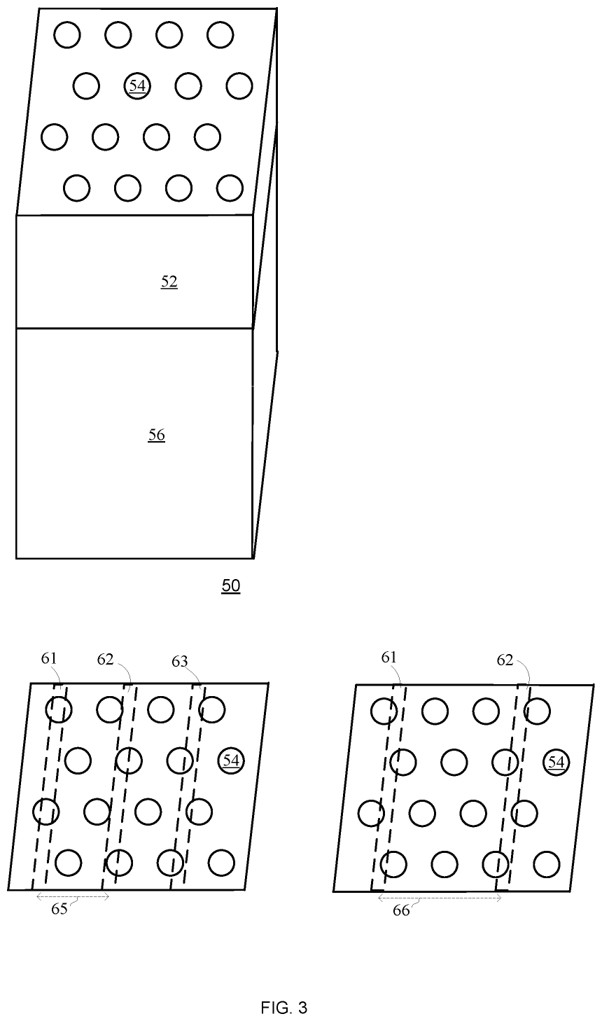

FIG. 3 illustrates an example of a structure 50 that includes an upper layer 52 that includes apertures 54, and a substrate 56.

FIG. 3 also illustrates a first example of a structured illumination of a pump beam that includes an illumination within three spaced apart radiation lines 61, 62 and 63—that are spaced apart from each other by a first pitch 65.

FIG. 3 further illustrates a second example of a structured illumination of a pump beam that includes an illumination within two spaced apart radiation lines 61 and 62—that are spaced apart from each other by a second pitch 66 that exceeds the first pitch.

Combined use of OCD and Thermo-response channels, enabled by joint HW implementation and dedicated modeling engine

As stated, the use of model-based interpretation for thermo-response channels allows its use for complex structure metrology. With OCD for characterization of the non-opaque regions and the consequent ability to estimate the pump absorption distribution, such implementation offers a comprehensive and simple metrology solution. Other mentioned methods (e.g. MIR scatterometry, picosecond ultrasonics), especially if combined together with an OCD channel, could offer competing capabilities. The key advantages of the approach proposed here:
a. Simple implementation and integration: especially for MTPT (although MHBBP is also significantly simpler than the mentioned alternatives).
b. Small measurement spot (compared to MIR scatterometry): with the pump beam defined by a laser, spot size can easily reach few microns diameters.
c. Finally, as offered sensitivities of the different techniques are highly dependent on the measured structure geometry and involved materials, it is to be expected that eventual performance will be significantly different in different cases.

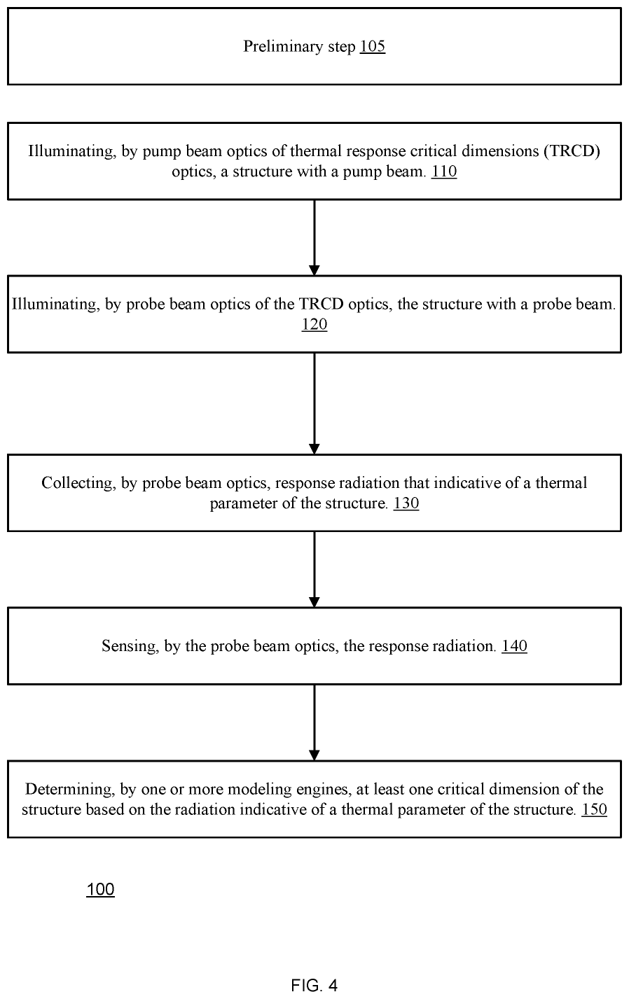

FIG. 4 illustrates an example of method 100.

Method 100 may include step 110 of illuminating, by pump beam optics of thermal response critical dimensions (TRCD) optics, a structure with a pump beam.

Step 110 is followed by step 120 of illuminating, by probe beam optics of the TRCD optics, the structure with a probe beam.

Step 120 is followed by step 130 of collecting, by probe beam optics, response radiation that indicative of a thermal parameter of the structure.

Step 130 is followed by step 140 of sensing, by the probe beam optics, the response radiation.

Step 140 is followed by step 150 of determining, by one or more modeling engines, at least one critical dimension of the structure based on the radiation indicative of a thermal parameter of the structure.

Steps 110, 120, 130, 140 may be repeated multiple times during multiple measurement iterations.

Step 110 may include illuminating the sample with a pump beam that is modulated. In this case step 150 may include extracting, by the one or more modeling engines, a phase different between the pump beam and the response radiation.

Two or more measurement iterations may differ from each other by at least one measurement iteration parameter.

The at least one measurement iteration parameter may include at least one of:
a. At least one pump beam parameter.
b. A pump beam frequency.
c. A pump beam polarization.
d. A pump beam angle of incidence.
e. A modulation frequency of the pump beam.
f. A lateral frequency (or a pitch) of a pump beam that is a structured pump beam.
g. A structure parameter of a pump beam that is a structured pump beam.
h. A probe beam parameter.
i. A probe beam frequency.
j. A probe beam polarization.
k. A probe beam angle of incidence.
l. A time difference between the pump beam and the probe beam.

The one or more modeling engines may include a TRCD modeling engine.

Step 150 may include using, by a TRCD modeling engine, a thermal module that takes into account a interaction of the pump beam with the structure, a heating of the structure due to the interaction, a time-dependent heat diffusion inside the structure, and an impact of the time-dependent heat diffusion on the response radiation.

Step 150 may include determining the response radiation, by applying a modulated photo thermal probe (MPTP) based simulation on the heat diffusion through the structure.

Method 100 may include preliminary step 105.

Preliminary step 105 may include at least one out of:
a. Generating the thermal model by the TRCD modeling engine.
b. Generating the thermal module by simulating a distribution of an electromagnetic field from the pump beam inside the structure and converting the distribution of the electromagnetic field to a distribution of heat within the structure.
c. Simulating a heat diffusion through the structure based on the distribution of heat within the structure and based on a time dependency of the pump beam.

The one or more modeling engines may include a TRCD modeling engine.

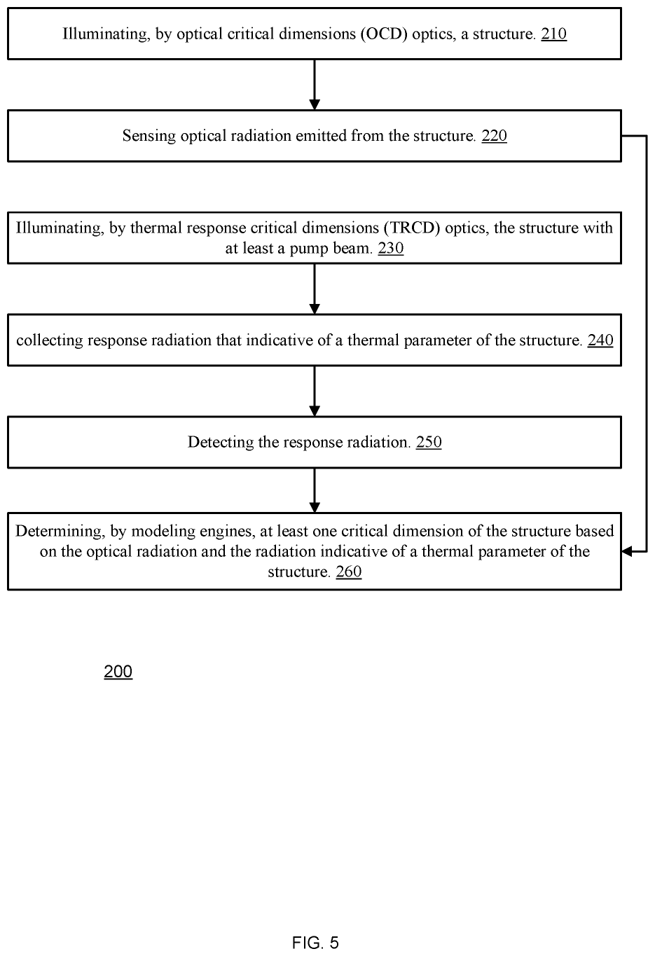

FIG. 5 illustrates an example of method 200.

Method 200 may include step 210 of illuminating, by optical critical dimensions (OCD) optics, a structure.

Step 210 is followed by step 220 of sensing optical radiation emitted from the structure.

Method 200 may also include step 230 of illuminating, by thermal response critical dimensions (TRCD) optics, the structure with at least a pump beam.

Step 230 is followed by step 240 of collecting response radiation that indicative of a thermal parameter of the structure.

Step 240 is followed by step 250 of detecting the response radiation.

Steps 220 and 250 are followed by step 260 of determining, by modeling engines, at least one critical dimension of the structure based on the optical radiation and the radiation indicative of a thermal parameter of the structure.

Method 200 may provide a combination of MPTP and OCD. For example—step 210 may include steps 110 and 120 of method 100.

Alternatively, method 200 may have a TRCD optics that illuminate the sample with a pump beam but not with a probe beam—and perform black body radiation based measurements.

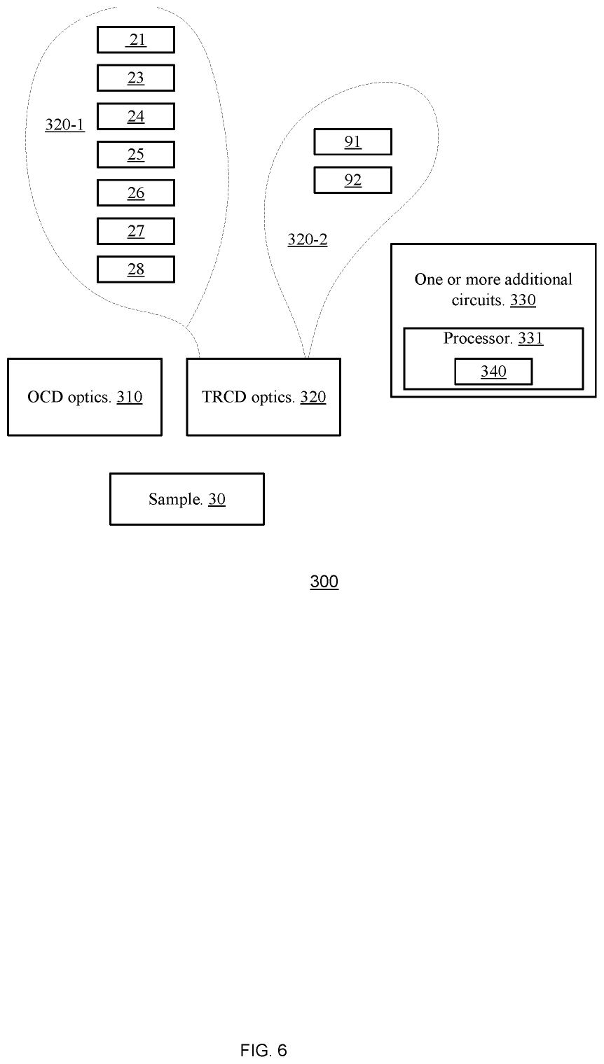

FIG. 6 illustrates examples of a sample 30 and a system 300 that includes OCD optics 310, TRCD optics 320, and one or more circuits 330 such as a processor 331 that is configured to execute modeling engines 340. Examples of a circuit of the one or more circuits—other than processor 331 may include a signal generator, a lock-in amplifier and the like.

The TRCD optics may be MPTP optics. An example of MPTP optics is provided in FIG. 2 and include components such as pump laser 21, DBS 23, objective lens 24, BS 26, probe filter 25, filter 27, and detector 28. This is illustrated by dashed box 320-1.

The TRCD optics may be black body radiation optics represented by dashed box 320-2. The TRCD optics and additional circuits for controlling the TRCD optics and processing detection signals may include:
a. Means for emitting a light beam (such as laser 91 and associated optical components), said light beam propagating in a first propagation path up to said layer of material.
b. Photothermal detection means (such as detector 92 and associated optical components) for detecting a heat flow (black body radiation) radiated by said layer of material heated by said light beam and supplying a measuring signal, said radiated heat flow propagating in a second propagation path up to the photothermal detection means.
c. Calculating means programmed to determine the thickness of said material layer on the basis of said supplied measuring signal. The light beam is sinusoidally modulated. The calculating means are adapted to extract from the measurement signal a sinusoidal component having a frequency that equals the modulation frequency and to determine a measurement phase of this sinusoidal component, and calculate a phase shift between component and the modulation.

The TRCD optics and additional circuits may also include an element for deflecting the light beam, arranged so as to deflect said light beam such that the first propagation path of the light beam is superimposed by the second propagation path of the radiated heat flow, between said deflection element and said layer of material, and an offset measuring head provided with two parts, one of which is rotatably movable in relation to the other, the movable part housing at least one reflective element and the other part of the measuring head housing the deflection.

An example of the black body radiation optics and additional circuits that also include the element for deflecting the light beam is illustrated in PCT patent application WO/FR2019/050936 publication serial number WO2019202275 which is incorporated herein by reference.

The modeling engines 340 may include at least one TRCD modeling engines and an one or more OCD modeling engines.

A TRCD engine may be is configured to determine the response radiation, by applying a Modulated Heating Black-Body Phase (MHBBP) based simulation on a heat diffusion through the structure.

A TRCD modeling engine may be configured to use a thermal module that takes into account a interaction of the pump beam with the structure, a heating of the structure due to the interaction, a time-dependent heat diffusion inside the structure, and an impact of the time-dependent heat diffusion on the response radiation.

A TRCD modeling engine may be configured to generate a thermal module.

A TRCD modeling engine may be configured to generate the thermal module by simulating a distribution of an electromagnetic field from the pump beam inside the structure and converting the distribution of the electromagnetic field to a distribution of heat within the structure.

A TRCD modeling engine may be configured to simulate a heat diffusion through the structure based on the distribution of heat within the structure and based on a time dependency of the pump beam.

A TRCD modeling engine is configured to determine the response radiation, by applying a modulated photo thermal probe (MPTP) based simulation on the heat diffusion through the structure.

Any combination of any module or unit listed in any of the figures, any part of the specification and/or any claims may be provided. Especially any combination of any claimed feature may be provided.

Any reference to the term “comprising” or “having” should be applied, mutatis mutandis, to “consisting” or to “essentially consisting of”.

The embodiment may also be implemented in a computer program for running on a computer system, at least including code portions for performing steps of a method according to the embodiment when run on a programmable apparatus, such as a computer system or enabling a programmable apparatus to perform functions of a device or system according to the embodiment. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on non-transitory computer readable media permanently, removably or remotely coupled to an information processing system. The non-transitory computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the embodiment has been described with reference to specific examples of embodiments of the embodiment. It will, however, be evident that various modifications and changes may be made therein without departing from the broader spirit and scope of the embodiment as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the embodiment described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments. Also for example, in one embodiment, the illustrated examples may be implemented as circuit located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuit or of logical representations convertible into physical circuit, such as in a hardware description language of any appropriate type.

Also, the embodiment is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiment have been illustrated and described herein, many modifications, substitutions, changes, and equivalents will now occur to those of ordinary skill in the art. It is, therefore, to be understood that the appended claims are intended to cover all such modifications and changes as fall within the true spirit of the embodiment.

We claim:

1. A metrology system, comprising:
thermal response critical dimensions (TRCD) optics that comprises pump beam optics and probe beam optics; wherein during a measurement iteration the pump beam optics are configured to illuminate a structure with a pump beam, and the probe beam optics are configured to illuminate the structure with a probe beam, to collect response radiation and to sense the response radiation; and
one or more modeling engines that are configured to determine at least one critical dimension of the structure based on the response radiation.

2. The metrology system according to claim 1, wherein the pump beam is modulated and wherein the one or more modeling engines are configured to extract, during the measurement iteration, a phase different between the pump beam and the response radiation.

3. The metrology system according to claim 2, wherein the TRCD optics are configured to perform multiple measurement iterations that differ from each other by at least one measurement iteration parameter.

4. The metrology system according to claim 3, wherein the at least one measurement iteration parameter comprises at least one pump beam parameter selected out of pump beam frequency, pump beam polarization or pump beam angle of incidence.

5. The metrology system according to claim 3, wherein the at least one measurement iteration parameter comprises a modulation frequency of the pump beam.

6. The metrology system according to claim 3, wherein the pump beam is a structured pump beam and wherein the at least one measurement iteration parameter comprises a lateral frequency of the structured pump beam.

7. The metrology system according to claim 3, wherein the pump beam is a structured pump beam and wherein the at least one measurement iteration parameter comprises a structure parameter of the structured pump beam.

8. The metrology system according to claim 3, wherein the at least one measurement iteration parameter comprises at least one probe beam parameter selected out of probe beam frequency, probe beam polarization or probe beam angle of incidence.

9. The metrology system according to claim 1, wherein the one or more modeling engines comprise a TRCD modeling engine.

10. The metrology system according to claim 9, wherein the TRCD modeling engine is configured to use a thermal module that takes into account a interaction of the pump beam with the structure, a heating of the structure due to the interaction, a time-dependent heat diffusion inside the structure, and an impact of the time-dependent heat diffusion on the response radiation.

11. The metrology system according to claim 10, wherein the TRCD modeling engine is configured to generate a thermal module.

12. The metrology system according to claim 11, wherein the TRCD modeling engine is configured to generate the thermal module by simulating a distribution of an electromagnetic field from the pump beam inside the structure and converting the distribution of the electromagnetic field to a distribution of heat within the structure.

13. The metrology system according to claim 12, wherein the TRCD modeling engine is configured to simulate a heat diffusion through the structure based on the distribution of heat within the structure and based on a time dependency of the pump beam.

14. The metrology system according to claim 13, wherein the TRCD modeling engine is configured to determine the response radiation, by applying a modulated photo thermal probe (MPTP) based simulation on the heat diffusion through the structure.

15. The metrology system according to claim 1, comprising optical critical dimensions (OCD) optics that are configured to illuminate the structure and sense optical radiation emitted from the structure; wherein the one or more modeling engines are configured to determine the at least one critical dimension of the structure also based on the sensed optical radiation.

16. The metrology system according to claim 15, wherein the one or more modeling engines comprise an OCD modeling engine.

17. A metrology method, comprising:
illuminating, by pump beam optics of thermal response critical dimensions (TRCD) optics, a structure with a pump beam;
illuminating, by probe beam optics of the TRCD optics, the structure with a probe beam;
collecting, by probe beam optics, response radiation that indicative of a thermal parameter of the structure;
sensing, by the probe beam optics, the response radiation; and
determining, by one or more modeling engines, at least one critical dimension of the structure based on the radiation indicative of a thermal parameter of the structure.

18. A non-transitory computer readable medium that stores instruction for:
illuminating, by pump beam optics of thermal response critical dimensions (TRCD) optics, a structure with a pump beam;
illuminating, by probe beam optics of the TRCD optics, the structure with a probe beam;
collecting, by probe beam optics, response radiation that indicative of a thermal parameter of the structure;
sensing, by the probe beam optics, the response radiation; and
determining, by one or more modeling engines, at least one critical dimension of the structure based on the radiation indicative of a thermal parameter of the structure.

19. A metrology system, comprising:
optical critical dimensions (OCD) optics that are configured to illuminate a structure and sense optical radiation emitted from the structure;
thermal response critical dimensions (TRCD) optics that are configured to illuminate the structure with at least a pump beam, to collect response radiation that indicative of a thermal parameter of the structure, and to detect the response radiation; and
modeling engines that are configured to determine at least one critical dimension of the structure based on the optical radiation and the radiation indicative of a thermal parameter of the structure.

20. The metrology system according to claim 19, wherein the TRCD optics are configured to illuminate the structure with the pump beam and to collect response radiation that is black body radiation.

21. The metrology system according to claim 20, wherein the response radiation is black body radiation; wherein the TRCD optics comprise an infrared sensor that is configured to collect the black body radiation; and wherein the modeling engines are configured to determine at least one critical dimension of the structure based on the sensed black body radiation and the sensed optical radiation.

22. The metrology system according to claim 19, wherein the modeling engines comprise a TRCD engine that is configured to determine the response radiation, by applying a Modulated Heating Black-Body Phase (MHBBP) based simulation on a heat diffusion through the structure.

23. A metrology method, comprising:
illuminating, by optical critical dimensions (OCD) optics, a structure;
sensing optical radiation emitted from the structure;
illuminating, by thermal response critical dimensions (TRCD) optics, the structure with at least a pump beam;
collecting response radiation that indicative of a thermal parameter of the structure;
detecting the response radiation; and
determining, by modeling engines, at least one critical dimension of the structure based on the optical radiation and the radiation indicative of a thermal parameter of the structure.

24. A non-transitory computer readable medium that stores instruction for:
illuminating, by optical critical dimensions (OCD) optics, a structure;
sensing optical radiation emitted from the structure;
illuminating, by thermal response critical dimensions (TRCD) optics, the structure with at least a pump beam;
collecting response radiation that indicative of a thermal parameter of the structure;
detecting the response radiation; and
determining, by modeling engines, at least one critical dimension of the structure based on the optical radiation and the radiation indicative of a thermal parameter of the structure.
